(19) United States
(12) Patent Application Publication
(10) Pub. No.: US 2026/0324855 A1
(43) Pub. Date: Oct. 22, 2026

(54) SIMPLE WARDROBE RACK

(71) Applicant: Gaatu, Inc., Tracy, CA (US)

(72) Inventor: Yubin PU, Tracy, CA (US)

(21) Appl. No.: 19/185,626

(22) Filed: Apr. 22, 2025

(51) Int. Cl. A47B 61/02; A47B 57/54

(52) U.S. Cl. CPC A47B 61/02; A47B 57/54

(57) ABSTRACT

The present application provides a simple wardrobe rack and relates to the field of furniture technology. The simple wardrobe rack includes: a vertical rod, a bearing member, a plurality of clips and a plurality of connecting sleeves. One of the vertical rod and the clip is provided with a limiting groove, and the other is provided with a limiting boss. The clip is engaged outside the vertical rod so that the limiting boss is engaged in the limiting groove; the connecting sleeve is provided outside the corresponding clip; the inner cylinder of the connecting sleeve is tapered, the outer wall of the clip at least partially fits the inner wall of the connecting sleeve, and the bearing member is connected to at least one connecting sleeve.

### TECHNICAL FIELD

The present application relates to the technical field of furniture technology, and more particularly to a simple wardrobe rack.

### BACKGROUND

Simple wardrobe racks are economical and easy to install furniture, which are widely used in homes, dormitories and other places. Usually, simple wardrobe racks are assembled from bearing objects, vertical rods and connecting members, among which the connecting members play an important role in connecting the bearing objects and the vertical rods and ensuring the overall stability of the wardrobe rack.

However, the connecting members in the existing simple wardrobe racks are prone to cracking and breaking under the conditions of long-term bearing of clothing weight, external force pulling, etc., resulting in a decrease in the overall stability of the simple wardrobe racks and even safety hazards.

### SUMMARY

An objective of embodiments of the present application is to provide a simple wardrobe rack to solve the technical problem that the connection of the simple wardrobe rack in the prior art is prone to cracking, resulting in a decrease in the overall stability of the wardrobe rack.

In order to achieve the above objective, the technical solution adopted in the present application is to provide a simple wardrobe rack, which includes: a vertical rod, a bearing member, a plurality of clips and a plurality of connecting sleeves, one of the vertical rod and the plurality of clips is provided with a limiting groove, and another one of the vertical rod and the plurality of clips is provided with a limiting boss, the plurality of clips are engaged outside the vertical rod such that the limiting boss is engaged inside the limiting groove ; each connecting sleeve is sleeved outside a corresponding clip; an inner cylinder of each connecting sleeve is tapered, an outer wall of the clip at least partially fits with an inner wall of the connecting sleeve, and the bearing member is connected to at least one of the plurality of connecting sleeves.

Optionally, a tapered angle of the inner cylinder of the connecting sleeve is ranged form 2° to 5°.

Optionally, a reinforcing ring is provided on an outside of the connecting sleeve.

Optionally, an outer wall of the clip is tapered, and a tapered angle of the clip is the same as a tapered angle of the inner cylinder of the connecting sleeve.

Optionally, the clip includes a first half clip and a second half clip, and the first half clip and the second half clip are engaged to surround the vertical rod.

Optionally, the simple wardrobe rack further includes a connecting assembly and a fixing rod, the connecting assembly includes a decorative cover and a fixing plate, the decorative cover is sleeved outside the fixing rod and covers the fixing plate, the fixing plate is provided with a plurality of first mounting holes, the plurality of first mounting holes are configured for a first fastener to pass through to connect the fixing plate to a fixing object, one end of the fixing rod is connected to the fixing plate, an other end of the fixing rod is connected to the vertical rod through a connector, or the other end of the fixing rod is connected to the connecting sleeve.

Optionally, each first mounting hole is a waist-shaped hole.

Optionally, the decorative cover is provided with a groove, the fixing plate includes a bottom plate and a connecting edge arranged on a circumference of the bottom plate, the connecting edge is plugged and fixed in the groove, and the plurality of first mounting holes are arranged on the bottom plate.

Optionally, one of a groove wall of the groove and an outer wall of the connecting edge is provided with an engagement slot, and another one is provided with a convex ridge, and the convex ridge is engaged in the engagement slot.

Optionally, the simple wardrobe rack includes at least two vertical rods arranged in parallel, the bearing member includes a telescopic rod, and two ends of the telescopic rod are connected to one connecting sleeve, respectively.

The beneficial effect of the simple wardrobe rack provided by the present application is that: compared with the prior art, the simple wardrobe rack of the present application is provided with a connecting sleeve on the outside of the clip, the inner cylinder of the connecting sleeve is tapered, and the outer wall of the clip at least partially fits the inner wall of the connecting sleeve, and the stress is dispersed by the tapered gradual cross-section, the stress concentration is reduced, therefore the fatigue resistance of the connecting sleeve is improved and the risk of cracking is reduced; in addition, after the bearing member carries an object, the tapered inner cylinder of the connecting sleeve will press down the clip, so that the connection between the connecting sleeve, the clip, and the vertical rod is more stable, thus the stability and durability of the entire simple wardrobe rack are improved.

### DESCRIPTION OF THE DRAWINGS

In order to explain the embodiments of the present application more clearly, a brief introduction regarding the accompanying drawings that need to be used for describing the embodiments of the present application or the prior art is given below; it is obvious that the accompanying drawings described as follows are only some embodiments of the present application, for those skilled in the art, other drawings can also be obtained according to the current drawings on the premise of paying no creative labor.

FIG. 1 is a structural schematic view of a simple wardrobe rack provided in an embodiment of the present application;

FIG. 2 is a partial structural schematic view of a simple wardrobe rack provided in an embodiment of the present application;

FIG. 3 is a partially enlarged exploded view of a simple wardrobe rack provided in an embodiment of the present application;

FIG. 4 is a structural schematic view of a clip provided in an embodiment of the present application;

FIG. 5 is a schematic view of a connection structure of both ends of a fixing rod provided in an embodiment of the present application;

FIG. 6 is a second schematic diagram of a connection structure of both ends of a fixing rod provided in an embodiment of the present application;

FIG. 7 is a structural schematic view of a connecting assembly in FIG. 6; and

FIG. 8 is a schematic view of matching of a mesh and a connecting sleeve provided in an embodiment of the present application.

In the drawings, the reference numerals are listed as follows:
10—vertical rod; 101—limiting groove; 21—clip; 210—limiting boss; 211—first half clip; 212—second half clip; 213—buckle; 214 connecting groove; 22—connecting sleeve; 221—reinforcing ring; 30—bearing member; 301—mesh; 302—clothes hanging rod; 303 telescopic rod; 40—fixing rod; 50—connecting assembly; 51—decorative cover; 511—groove; 52—fixing plate; 521—bottom plate; 522—connecting edge; 523—first mounting hole; 524—second mounting hole; 525—countersunk groove; and 60—second fastener.

### DETAILED DESCRIPTION OF EMBODIMENTS

In order to make the purpose, the technical solution and the advantages of the present application be clearer and more understandable, the present application will be further described in detail below with reference to accompanying figures and embodiments. It should be understood that the specific embodiments described herein are merely intended to illustrate but not to limit the present application.

It is noted that when a component is referred to as being “fixed to” or “disposed on” another component, it can be directly or indirectly on another component. When a component is referred to as being “connected to” another component, it can be directly or indirectly connected to another component.

In the description of the present application, it needs to be understood that, directions or location relationships indicated by terms such as “length”, “width”, “up”, “down”, “front”, “rear”, “left”, “right”, “vertical”, “horizontal”, “top”, “bottom”, “inside”, “outside”, and so on are the directions or location relationships shown in the accompanying figures, which are only intended to describe the present application conveniently and simplify the description, but not to indicate or imply that an indicated device or component must have specific locations or be constructed and manipulated according to specific locations; therefore, these terms shouldn't be considered as any limitation to the present application.

In addition, terms “the first” and “the second” are only used in describe purposes, and should not be considered as indicating or implying any relative importance, or implicitly indicating the number of indicated technical features. As such, technical feature(s) restricted by “the first” or “the second” can explicitly or implicitly comprise one or more such technical feature(s). In the description of the present application, “a plurality of” means two or more, unless there is additional explicit and specific limitation.

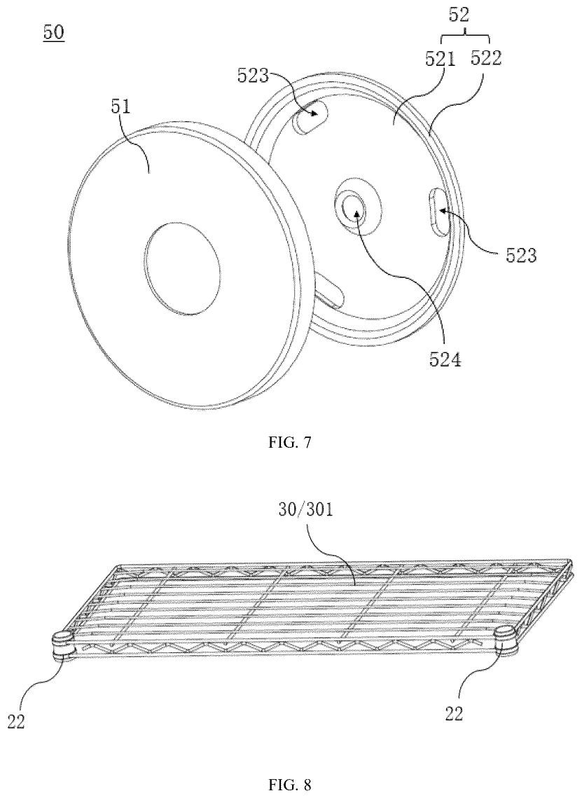

As shown in FIGS. 1 to 8, and now the simple wardrobe rack provided by the embodiment of the present application is described.

As shown in FIGS. 1 to 4, the simple wardrobe rack includes a vertical rod 10, a clip 21, a connecting sleeve 22 and a bearing member 30 for bearing objects. One of the vertical rod 10 and the clip 21 is provided with a limiting groove 101, and the other is provided with a limiting boss 210. The clip 21 is engaged outside the vertical rod 10 so that the limiting boss 210 is engaged in the limiting groove 101. There are multiple clips 21 and connecting sleeves 22, and the connecting sleeves 22 are sleeved outside the corresponding clips 21. The inner cylinder of the connecting sleeve 22 is tapered, and the outer wall of the clip 21 is at least partially fitted with the inner wall of the connecting sleeve 22. The bearing member 30 is fixedly connected to at least one connecting sleeve 22.

The limiting groove 101 is an annular groove, and the limiting boss 210 is an annular convex ridge. The shape of the limiting boss 210 is adapted to the shape of the limiting groove 101 to achieve a firm clamping fit. Alternatively, the limiting groove 101 includes a plurality of arc grooves, the plurality of arc grooves are located on the same circumference, and the sum of the arc lengths corresponding to the plurality of arc grooves is not less than half of the entire arc, so as to ensure the clamping strength; correspondingly, the limiting boss 210 includes a plurality of engagement blocks spaced apart, and the plurality of engagement blocks are located on the same ring. The plurality of engagement blocks correspond to the plurality of arc grooves one by one. Optionally, the cross-section of the limiting groove 101 along a groove depth direction is an arc shape. After the limiting boss 210 is engaged into the notch of the limiting groove 101, the limiting boss 210 will be tightly held by the groove wall of the limiting groove 101 to prevent the limiting boss 210 from falling out of the limiting groove 101.

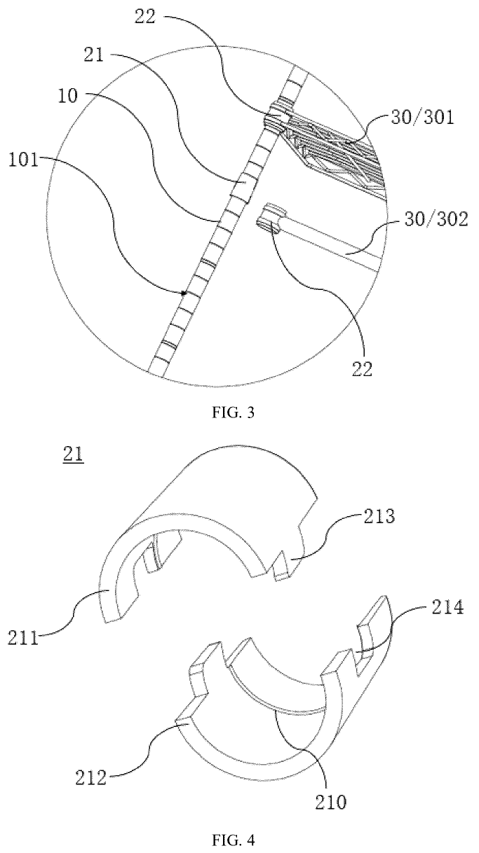

In an optional embodiment, as shown in FIG. 3, the vertical rod 10 is provided with a plurality of limiting grooves 101 along the length direction, and each limiting groove 101 is arranged in an annular shape around the circumference of the vertical rod 10. The inner wall of the clip 21 is provided with a plurality of annular limiting bosses 210, and the connection stability is improved by increasing the number of limiting bosses 210 and the limiting grooves 101 that are snap-fitted. For example, the inner wall of the clip 21 is provided with two limiting bosses 210, and the two limiting bosses 210 are correspondingly matched with two of the limiting grooves 101 of the vertical rod 10. For the convenience of installation, the vertical rod 10 is provided with a plurality of groups of limiting grooves 101, and each group of limiting grooves 101 is adapted to the limiting boss 210 of one clip 21, so that the installation position of the clip 21 on the vertical rod 10 can be adjusted as needed, so that the user can adjust the setting height of the bearing member 30 according to actual needs. In another optional embodiment, the vertical rod 10 is provided with a plurality of limiting bosses 210 along the length direction, and the inner wall of the clip 21 is recessed to form the limiting grooves 101. When the clip 21 is installed outside the vertical rod 10, the limiting bosses 210 are engaged in the limiting grooves 101.

The bearing member 30 can include at least one selected from a group of a clothes hanging rod 302, a rod body for fixing on a wall, a transversely arranged reinforcing rod, a mesh 301, a mesh basket, and a partition. In the embodiment, the clip 21 is in the shape of a sleeve and is sleeved outside the vertical rod 10. The bearing member 30 is fixed to the vertical rod 10 by means of a set of clips 21 and a connecting sleeve 22.

In one embodiment, the outer wall of the clip 21 is completely fitted with the inner wall of the connecting sleeve 22. For example, the inner cylinder of the connecting sleeve 22 and the outer wall of the clip 21 are both conical and have the same tapered angle, and the heights of the two are equal or the height of the connecting sleeve 22 is slightly greater than the height of the clip 21, so that the connecting sleeve 22 completely covers the clip 21 to improve the protective performance. In another embodiment, the inner wall of the connecting sleeve 22 is only partially fitted with the outer wall of the clip 21. For example, the outer wall of the clip 21 is cylindrical with a conical head. When the connecting sleeve 22 is sleeved outside the clip 21, the connecting sleeve 22 only partially contacts the conical head of the outer wall of the clip 21, and the contact surface is small. For another example, the inner wall of the connecting sleeve 22 and the outer wall of the clip 21 are both conical, and the tapered angles of the two are the same, the height of the connecting sleeve 22 is less than the height of the clip 21, so that only part of the outer wall of the clip 21 is covered by the connecting sleeve 22. During use, the tapered gradual cross-section of the connecting sleeve 22 increases the contact area and disperses the stress, the stress concentration is reduced, the fatigue resistance of the connecting sleeve 30 is improved, and the risk of cracking is reduced.

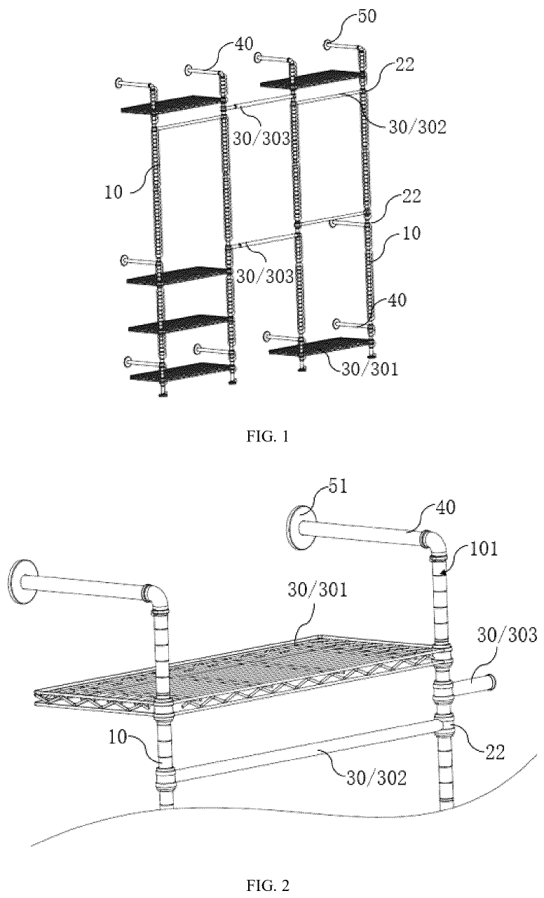

It should be noted that the connecting sleeve 22 and the clip 21 are used as a set, and the connecting sleeve 22 is sleeved outside the corresponding clip 21. One, two or more connecting sleeves 22 can be connected to one bearing member 30, and the specific number of connecting sleeves 22 is determined according to the specific structure and installation position of the bearing member 30. Taking the bearing member 30 being a mesh 301 as an example, two adjacent corners of the mesh 301 are connected to one vertical rod 10 respectively, and the entire mesh 301 is in a suspended state. As shown in FIG. 8, two corners of the mesh 301 are respectively welded or integrally injection molded with a connecting sleeve 22, and each connecting sleeve 22 is configured with one clip 21 so as to be fixed at the target position of the vertical rod 10, and the mesh 301 can be installed on the vertical rod 10 without the need for an installation tool during assembly. Alternatively, the four corners of the mesh 301 are respectively connected to one vertical rod 10, and the four corners of the mesh 301 are respectively connected to a connecting sleeve 22, and the four connecting sleeves 22 are correspondingly connected to the corresponding clips 21 on the four vertical rods 10. Taking the bearing member 30 being a clothes hanging rod 302 as an example, as shown in FIG. 2, the two ends of the clothes hanging rod 302 are respectively connected to one vertical rod 10, and for this purpose, a set of connecting sleeves 22 and clips 21 are installed at both ends of the clothes hanging rod 302. Taking the bearing member 30 being a rod body fixed on the wall as an example, one end of the rod body is fixed to the wall, and a set of connecting sleeves 22 and clips 21 are set at the other end to connect with the vertical rod 10.

Compared with the prior art, the simple wardrobe rack provided in the present application has a connecting sleeve 22 sleeved outside the clip 21, and the inner cylinder of the connecting sleeve 22 is tapered, which disperses stress through the tapered gradual cross-section, the stress concentration is reduced, therefore the fatigue resistance of the connecting sleeve 22 is improved and the risk of cracking is reduced; in addition, after the bearing member 30 carries an object, the conical inner cylinder of the connecting sleeve 22 will press down the clip 21, so that the connection between the connecting sleeve 22, the clip 21, and the vertical rod 10 is more stable, thus the stability and durability of the entire simple wardrobe rack are improved.

In another embodiment of the present application, the tapered angle of the inner cylinder of the connecting sleeve 22 is ranged from 2° to 5°. The tapered angle of the inner cylinder refers to the angle formed by the axis of the inner cylinder and the cone generatrix. The tapered angle of the inner cylinder of the connecting sleeve 22 is 2°, 3°or 5°.

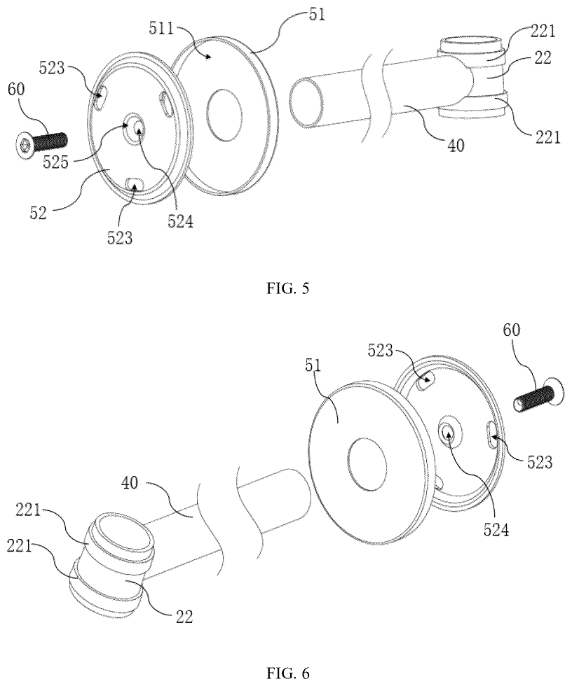

In another embodiment of the present application, as shown in FIGS. 5 and 6, a reinforcing ring 221 is provided on the outside of the connecting sleeve 22. Specifically, a plurality of reinforcing rings 221 are provided. For example, as shown in FIGS. 5 and 6, two reinforcing rings 221 are provided, and the two reinforcing rings 221 are arranged at intervals along the axial direction of the connecting sleeve 22.

In another embodiment of the present application, the outer wall of the clip 21 is tapered, and the tapered angle of the clip 21 is the same as the tapered angle of the inner cylinder of the connecting sleeve 22. in the embodiment, the height of the connecting sleeve 22 can be equal to or different from the height of the clip 21. For example, the height of the connecting sleeve 22 is equal to the height of the clip 21, or the height of the connecting sleeve 22 is slightly greater than the height of the clip 21, so that the connecting sleeve 22 completely covers the clip 21, the aesthetics is improved and the contact area is increased, and the stress concentration is further reduced.

In another embodiment of the present application, as shown in FIG. 4, the clip 21 includes a first half clip 211 and a second half clip 212, and the first half clip 211 and the second half clip 212 are engaged to surround the vertical rod 10. The first half clip 211 and the second half clip 212 are both semicircular sleeve-shaped, and the engagement sides of the first half clip 211 and the second half clip 212 are both provided with a buckle 213 and a connecting groove 214, and the buckle 213 is engaged in the connecting groove 214, so that the first half clip 211 and the second half clip 212 are engaged together to form a circular sleeve, which is tightly held on the outside of the vertical rod 10. As shown in FIG. 4, the first half clip 211 is provided with a buckle 213 and a connecting groove 214, and the second half clip 212 is provided with a buckle 213 and a connecting groove 214, and the buckle 213 on the first half clip 211 cooperates with the connecting groove 214 on the second half clip 212, and the connecting groove 214 on the first half clip 211 cooperates with the buckle 213 on the second half clip 212. In the case where the clip 21 is provided with a limiting groove 101 and the limiting groove 101 is an annular groove, the first half clip 211 and the second half clip 212 are respectively provided with a groove body; when the first half clip 211 and the second half clip 212 are engaged together, the groove body on the first half clip 211 and the groove body on the second half clip 212 are spliced to form the limiting groove 101. Similarly, in the case where the clip 21 is provided with a limiting boss 210 and the limiting boss 210 is annular, the first half clip 211 and the second half clip 212 are respectively provided with a boss; when the first half clip 211 and the second half clip 212 are engaged together, the boss on the first half clip 211 and the boss on the second half clip 212 are spliced to form the annular limiting boss 210.

In one embodiment of the present application, the simple wardrobe rack is a floor-standing rack-type wardrobe rack. Specifically, the simple wardrobe rack also includes a connecting crossbar, and the vertical rod 10, the connecting crossbar and the bearing member 30 are connected to form a square frame that can stand on the ground. In another embodiment of the present application, the simple wardrobe rack is a wall wardrobe rack. As shown in FIGS. 2 and 5, the simple wardrobe rack also includes a connecting assembly 50 and a fixing rod 40. The connecting assembly 50 includes a decorative cover 51 and a fixing plate 52. The decorative cover 51 is sleeved outside the fixing rod 40 and covers the fixing plate 52. The fixing plate 52 is provided with a first mounting hole 523, and the first mounting hole 523 is used for a first fastener to pass through. The first fastener is used to connect the fixing plate 52 to a fixing object. One end of the fixing rod 40 is connected to the fixing plate 52, and the other end of the fixing rod 40 is connected to the vertical rod 10 through a connector, or the other end of the fixing rod 40 is connected to the connecting sleeve 22.

Two, three or four first mounting holes 523 are provided, and the multiple first mounting holes 523 are arranged in a circular array. A plurality of first fasteners pass through the corresponding first mounting holes 523 one by one to press the fixing plate 52 onto a fixing object such as a wall or a cabinet panel. In which, the first fastener can be a screw. The aperture of the first mounting hole 523 is equivalent to the outer diameter of the rod of the screw. After the screw is fixed to the wall, the nut of the screw is pressed on the side of the fixing plate 52 away from the wall, thereby fixing the fixing plate 52 to the wall. The decorative cover 51 is covered on the fixing plate 52 by means of a buckle 213 or an interference fit, the first fastener is shielded, the aesthetics is improved while preventing dust from corroding the first fastener, and the durability of the first fastener is improved. In one embodiment, as shown in FIGS. 5 to 7, the fixing plate 52 and the decorative cover 51 are both circular structures, and the three first mounting holes 523 are arranged in a circular array around the center of the fixing plate 52.

A plurality of fixing rods 40 are provided. In one embodiment, the plurality of fixing rods 40 are connected to the vertical rod 10 using a connector. The top of the vertical rod 10 abuts against the roof, and the fixing rods 40 are arranged between the vertical rod 10 and the wall, and one end of each fixing rod 40 is connected to the vertical rod 10 through a T-shaped connector. Alternatively, the fixing rod 40 connected to the top of the vertical rod 10 is connected to the vertical rod 10 by a bent connector, and the other fixing rods 40 are connected to the vertical rod 10 by a T-shaped connector. In another embodiment, a plurality of fixing rods 40 are connected to the vertical rod 10 by a set of clips 21 and connecting sleeves 22. For example, the top of the vertical rod 10 abuts against the roof, and the fixing rods 40 are arranged between the vertical rod 10 and the wall, and each fixing rod 40 is connected to the vertical rod 10 by a set of clips 21 and connecting sleeves 22. In another embodiment, some fixing rods 40 are connected to the vertical rod 10 by a connector, and the other fixing rods 40 are connected to the vertical rod 10 by a set of clips 21 and connecting sleeves 22. As shown in FIGS. 2, 5 and 6, the fixing rod 40 connected to the top of the vertical rod 10 is connected to the vertical rod 10 through a bent connector, and the other end is fixedly connected to the wall or other fixing objects through a connecting assembly 50. One end of the fixing rod 40 connected to the non-end portion of the vertical rod 10 is fixedly connected to a wall or other fixing object, and the other end is fixedly connected to a connecting sleeve 22. The connecting sleeve 22 is sleeved outside the corresponding clip 21, and is thus fixed to the vertical rod 10 through the clip 21 and the connecting sleeve 22. During installation, the connecting assembly 50 is arranged only at one end of the fixing rod 40 fixed to the fixing object.

When installing the simple wardrobe rack, the vertical rod 10 and the bearing member 30 are spliced and formed through the clip 21 and the connecting sleeve 22, and the fixing rod 40 and the fixing plate 52 are pre-fixed together, and then the fixing plate 52 is fitted with the fixing object, and the fixing plate 52 is fixed to the fixing object with a first fastener to prevent the simple wardrobe rack from tipping over and improve the safety and stability of the simple wardrobe rack. Finally, the decorative cover 51 is covered on the fixing plate 52 to cover the first fastener. In addition, the connecting assembly 50 can also make the simple wardrobe rack fit with the wall and other fixing objects, therefore the utilization rate of the indoor space is improved.

In another embodiment of the present application, the first mounting hole 523 is a waist-shaped hole.

Compared with the prior art, the simple wardrobe rack provided by the present application provides a first mounting hole 523 being a waist-shaped hole, so that the position of the first fastener can be fine-tuned, which is convenient for installation; at the same time, in addition to the fixing plate 52, the connecting assembly 50 also includes a decorative cover 51, which can cover the first fastener, the aesthetics of the entire simple wardrobe rack is improved while prevent the first fastener from contacting with external humid air, therefore the durability of the first fastener is improved.

In another embodiment of the present application, as shown in FIGS. 5 to 7, the decorative cover 51 is provided with a groove 511, and the fixing plate 52 includes a bottom plate 521 and a connecting edge 522 arranged on the circumference of the bottom plate 521. The connecting edge 522 is inserted and fixed in the groove 511, and a first mounting hole 523 is arranged on the bottom plate 521. The bottom plate 521 is a flat plate for fitting against a wall. The first mounting hole 523 is arranged on the bottom plate 521 for fitting the fixing plate 52 on the wall with a first fastener. The connecting edge 522 is folded around the circumference of the bottom plate 521 toward a side away from the wall. When the connecting edge 522 is inserted into the groove 511, the outer wall of the connecting edge 522 fits against the groove wall of the groove 511, so that the decorative cover 51 and the fixing plate 52 are interference fit. In an optional embodiment, the connecting edge 522 is arranged in an annular shape. In another optional embodiment, the connecting edge 522 includes a plurality of lugs spaced apart, and during the process of inserting the connecting edge 522 into the groove 511, the slight deformation of the plurality of lugs can facilitate the interference fit between the decorative cover 51 and the fixing plate 52.

In another embodiment of the present application, one of the groove wall of the groove 511 and the outer wall of the connecting edge 522 is provided with a engagement slot, and the other is provided with a convex ridge, and the convex ridge is engaged in the engagement slot. For example, the groove wall of the groove 511 is provided with an annular engagement slot; the connecting edge 522 is convex outward to form a convex ridge, and the convex ridge is engaged in the engagement slot to improve the connection stability between the decorative cover 51 and the fixing plate 52. Alternatively, the groove wall of the groove 511 is provided with a convex ridge, which is annular or includes a plurality of protrusions spaced apart; the outer wall of the connecting edge 522 is provided with an engagement slot. When the decorative cover 51 is covered on the fixing plate 52, the convex ridge is engaged in the engagement slot. It is also possible to simultaneously set the engagement slot and the convex ridge on the groove wall of the groove 511 and the outer wall of the connecting edge 522, as long as the engagement slot and the convex ridge in the decorative cover 51 and the fixing plate 52 are arranged correspondingly.

In another specific embodiment of the present application, as shown in FIG. 5, the fixing plate 52 is provided with a countersunk groove 525, and the bottom of the countersunk groove 525 is provided with a second mounting hole 524. The second mounting hole 524 is used for the second fastener 60 to pass through to connect the fixing plate 52 with the fixing rod 40. The second fastener 60 is a screw, which passes through the second mounting hole 524 and is connected to the fixing rod 40, therefore the fixing rod 40 and the fixing plate 52 are fixed together. In the case where the screw is a flat head screw, the countersunk groove 525 is a circular groove that can accommodate the nut of the flat head screw. In the case where the screw is a countersunk screw, the countersunk groove 525 is a conical groove to match the conical head of the screw. Thus, it is ensured that the screws are flush with the surface of the fixing plate 52 after connecting the fixing rod 40 and the fixing plate 52, so that when the fixing plate 52 is fixed to the wall, the screws will not hinder the bottom plate 521 from fitting with the wall.

In another specific embodiment of the present application, as shown in FIGS. 5 to 7, a plurality of first mounting holes 523 are arranged in a circular array around the hole axis of the second mounting hole 524, so that the fixing plate 52 is fastened to the wall and the force is balanced at all places.

In another specific embodiment of the present application, the outer wall of the decorative cover 51 is provided with an anti-slip structure. The anti-slip structure is an anti-slip pattern or anti-slip convex points. For example, the anti-slip structure includes a plurality of anti-slip patterns, which are straight strips and extend along the groove depth direction of the groove 511 on the decorative cover 51. By providing an anti-slip structure, it is convenient to hold the decorative cover 51 for covering and disassembly operations.

In another specific embodiment of the present application, the simple wardrobe rack also includes a dust cover or a shielding curtain to prevent dust from falling on the vertical rod 10. As shown in FIG. 1, the bearing member 30 includes a telescopic rod 303, and the length of the telescopic rod 303 is adjustable. The simple wardrobe rack includes at least two parallel vertical rods 10, and two ends of the telescopic rod 303 are respectively connected to one connecting sleeve 22, and the connecting sleeves 22 at both ends of the telescopic rod 303 are sleeved on the outside of the corresponding clips 21 on the vertical rod 10. By setting the telescopic rod 303, the lateral distance between the two vertical rods 10 can be adjusted, thereby making the lateral size of the simple wardrobe rack adjustable, so that it can adapt to installation spaces of different sizes. Specifically, the telescopic rod 303 includes a first rod body and a second rod body, and the first rod body is inserted in the second rod body. The length of the entire telescopic rod 303 is adjusted by adjusting the depth of the first rod body inserted in the second rod body. As shown in FIG. 1, one end of the first rod body away from the second rod body and one end of the second rod body away from the first rod body are respectively connected to the connecting sleeve 22, and the connecting sleeve 22 is used in conjunction with the clip 21 to connect the two ends of the telescopic rod 303 to the vertical rod 10 respectively. It is understandable that the telescopic rod 303 can be used as a clothes hanging rod or only as an adjustment rod.

The above description is only a preferred embodiment of the present application and is not intended to limit the present application. Any modifications, equivalent replacements and improvements made within the spirit and principles of the present application shall be included in the protection scope of the present application.

1. A simple wardrobe rack, comprising:
a vertical rod,
a bearing member,
a plurality of clips, and
a plurality of connecting sleeves;
wherein one of the vertical rod and the plurality of clips is provided with a limiting groove, and another one of the vertical rod and the plurality of clips is provided with a limiting boss, the plurality of clips are engaged outside the vertical rod such that the limiting boss is engaged inside the limiting groove; each connecting sleeve of the plurality of connecting sleeves is sleeved outside a corresponding clip of the plurality of clips; an inner cylinder of each connecting sleeve of the plurality of connecting sleeves is tapered, an outer wall of the corresponding clip of the plurality of clips at least partially fits with an inner wall of a corresponding connecting sleeve of the plurality of connecting sleeves, and the bearing member is connected to at least one of the plurality of connecting sleeves.

2. The simple wardrobe rack according to claim 1, wherein a tapered angle of the inner cylinder of the connecting sleeve is ranged from 2° to 5°.

3. The simple wardrobe rack according to claim 1, wherein a reinforcing ring is provided on an outside of the connecting sleeve.

4. The simple wardrobe rack according to claim 1, wherein an outer wall of the corresponding clip of the plurality of clips is tapered, and a tapered angle of the corresponding clip of the plurality of clips is the same as a tapered angle of the inner cylinder of the corresponding connecting sleeve of the plurality of connecting sleeves.

5. The simple wardrobe rack according to claim 1, wherein the corresponding clip of the plurality of clips comprises a first half clip and a second half clip, and the first half clip and the second half clip are engaged to surround the vertical rod.

6. The simple wardrobe rack according to claim 1, wherein the simple wardrobe rack further comprises a connecting assembly and a fixing rod, the connecting assembly comprises a decorative cover and a fixing plate, the decorative cover is sleeved outside the fixing rod and covers the fixing plate, the fixing plate is provided with a plurality of first mounting holes, the plurality of first mounting holes are configured for a first fastener to pass through to connect the fixing plate to a fixing object, one end of the fixing rod is connected to the fixing plate, an other end of the fixing rod is connected to the vertical rod through a connector, or the other end of the fixing rod is connected to the connecting sleeve.

7. The simple wardrobe rack according to claim 6, wherein each first mounting hole is a waist-shaped hole.

8. The simple wardrobe rack according to claim 6, wherein the decorative cover is provided with a groove, the fixing plate comprises a bottom plate and a connecting edge arranged on a circumference of the bottom plate, the connecting edge is plugged and fixed in the groove, and the plurality of first mounting holes are arranged on the bottom plate.

9. The simple wardrobe rack according to claim 8, wherein one of a groove wall of the groove and an outer wall of the connecting edge is provided with an engagement slot, and another one is provided with a convex ridge, and the convex ridge is engaged in the engagement slot.

10. The simple wardrobe rack according to claim 1, wherein the simple wardrobe rack comprises at least two vertical rods arranged in parallel, the bearing member comprises a telescopic rod, and two ends of the telescopic rod are connected to one connecting sleeve, respectively.

11. The simple wardrobe rack according to claim 2, wherein the corresponding clip of the plurality of clips comprises a first half clip and a second half clip, and the first half clip and the second half clip are engaged to surround the vertical rod.

12. The simple wardrobe rack according to claim 3, wherein the corresponding clip of the plurality of clips comprises a first half clip and a second half clip, and the first half clip and the second half clip are engaged to surround the vertical rod.

13. The simple wardrobe rack according to claim 4, wherein the corresponding clip of the plurality of clips comprises a first half clip and a second half clip, and the first half clip and the second half clip are engaged to surround the vertical rod.

14. The simple wardrobe rack according to claim 2, wherein the simple wardrobe rack further comprises a connecting assembly and a fixing rod, the connecting assembly comprises a decorative cover and a fixing plate, the decorative cover is sleeved outside the fixing rod and covers the fixing plate, the fixing plate is provided with a plurality of first mounting holes, the plurality of first mounting holes are configured for a first fastener to pass through to connect the fixing plate to a fixing object, one end of the fixing rod is connected to the fixing plate, an other end of the fixing rod is connected to the vertical rod through a connector, or the other end of the fixing rod is connected to the connecting sleeve.

15. The simple wardrobe rack according to claim 3, wherein the simple wardrobe rack further comprises a connecting assembly and a fixing rod, the connecting assembly comprises a decorative cover and a fixing plate, the decorative cover is sleeved outside the fixing rod and covers the fixing plate, the fixing plate is provided with a plurality of first mounting holes, the plurality of first mounting holes are configured for a first fastener to pass through to connect the fixing plate to a fixing object, one end of the fixing rod is connected to the fixing plate, an other end of the fixing rod is connected to the vertical rod through a connector, or the other end of the fixing rod is connected to the connecting sleeve.

16. The simple wardrobe rack according to claim 4, wherein the simple wardrobe rack further comprises a connecting assembly and a fixing rod, the connecting assembly comprises a decorative cover and a fixing plate, the decorative cover is sleeved outside the fixing rod and covers the fixing plate, the fixing plate is provided with a plurality of first mounting holes, the plurality of first mounting holes are configured for a first fastener to pass through to connect the fixing plate to a fixing object, one end of the fixing rod is connected to the fixing plate, an other end of the fixing rod is connected to the vertical rod through a connector, or the other end of the fixing rod is connected to the connecting sleeve.

17. The simple wardrobe rack according to claim 2, wherein the simple wardrobe rack comprises at least two vertical rods arranged in parallel, the bearing member comprises a telescopic rod, and two ends of the telescopic rod are connected to one connecting sleeve, respectively.

18. The simple wardrobe rack according to claim 3, wherein the simple wardrobe rack comprises at least two vertical rods arranged in parallel, the bearing member comprises a telescopic rod, and two ends of the telescopic rod are connected to one connecting sleeve, respectively.

19. The simple wardrobe rack according to claim 4, wherein the simple wardrobe rack comprises at least two vertical rods arranged in parallel, the bearing member comprises a telescopic rod, and two ends of the telescopic rod are connected to one connecting sleeve, respectively.
